(19) United States
(12) Patent Application Publication
(10) Pub. No.: US 2011/0304305 A1
(43) Pub. Date: Dec. 15, 2011

(54) APPARATUS AND METHOD FOR A CAPACITIVE ELEMENT IN A STRUCTURE

(75) Inventors: Markku Antti Kyosti ROUVALA, Helsinki (FI); Tapani VON RAUNER, Helsinki (FI)

(73) Assignee: NOKIA CORPORATION, Espoo (FI)

(21) Appl. No.: 12/816,324

(22) Filed: Jun. 15, 2010

(51) Int. Cl. H02J 7/00; H01G 9/155

(52) U.S. Cl. 320/167; 361/502; 29/25.03

(57) ABSTRACT

In accordance with an example embodiment of the present invention, an apparatus is provided, comprising first and second circuit boards, and an electrolyte, the first and second circuit boards each comprising a capacitive element, the apparatus being configured such that a chamber is defined between the first and second circuit boards with the capacitive elements contained therein and facing one another, the chamber comprising the electrolyte, the apparatus being configured to store electrical charge when a potential difference is applied between the capacitive elements, and the apparatus further comprising an electrical connector between the first and second circuit boards, the electrical connector configured to enable a flow of electrical charge from the capacitive elements to provide power to one or more electrical components when the apparatus discharges.

### TECHNICAL FIELD

The present disclosure relates to the field of so-called “supercapacitors” and such like, associated apparatus, methods and computer programs.

### BACKGROUND

Multimedia enhancement modules in portable electronic devices (such as camera flash modules, loudspeaker driver modules, and power amplifier modules for electromagnetic transmission) require short power bursts. Typically, electrolytic capacitors are used to power LED and xenon flash modules and conventional capacitors are used to power loudspeaker driver modules.

### SUMMARY

According to a first aspect, there is provided an apparatus, the apparatus comprising first and second circuit boards, and an electrolyte, the first and second circuit boards each comprising a capacitive element, the apparatus being configured such that a chamber is defined between the first and second circuit boards with the capacitive elements contained therein and facing one another, the chamber comprising the electrolyte, the apparatus being configured to store electrical charge when a potential difference is applied between the capacitive elements, and the apparatus further comprising an electrical connector between the first and second circuit boards, the electrical connector configured to enable a flow of electrical charge from the capacitive elements to provide power to one or more electrical components when the apparatus discharges.

According to a further aspect, there is provided a method comprising: providing first and second circuit boards, the first and second circuit boards each comprising a capacitive element; configuring the first and second circuit boards to define a chamber between the first and second circuit boards with the capacitive elements contained therein and facing one another; providing an electrolyte within the chamber; and providing an electrical connector between the first and second circuit boards to produce an apparatus, the apparatus comprising the first and second circuit boards, the electrolyte, and the electrical connector, the apparatus being configured to store electrical charge when a potential difference is applied between the capacitive elements, and the electrical connector being configured to enable a flow of electrical charge from the capacitive elements to provide power to one or more electrical components when the apparatus discharges.

According to a further aspect, there is provided a computer program product, comprising computer code configured to control at least one of charging and discharging of an apparatus, the apparatus comprising first and second circuit boards, and an electrolyte, the first and second circuit boards each comprising a capacitive element, the apparatus configured such that a chamber is defined between the first and second circuit boards with the capacitive elements contained therein and facing one another, the chamber comprising the electrolyte, the apparatus being configured to store electrical charge when a potential difference is applied between the capacitive elements, the apparatus further comprising an electrical connector between the first and second circuit boards and a switch, the electrical connector configured to enable a flow of electrical charge from the capacitive elements to provide power to one or more electrical components when the apparatus discharges, the switch configured to connect and disconnect the electrical connector, disconnection of the electrical connector configured to allow the apparatus to be charged, and connection of the electrical connector configured to allow the apparatus to be discharged, the computer program product comprising computer code configured to operate the switch to cause charging and discharging of the apparatus.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1a illustrates schematically a capacitor;

FIG. 1b illustrates schematically an electrolytic capacitor;

FIG. 1c illustrates schematically an embodiment of a so-called supercapacitor;

FIG. 2 illustrates schematically (in cross section) a supercapacitor integrated within a flexible printed circuit structure;

FIG. 3a illustrates schematically the flexible printed circuit structure of FIG. 2 configured to define a chamber between the first and second circuit boards;

FIG. 3b illustrates schematically the flexible printed circuit structure of FIG. 3a in plan view;

FIG. 4 illustrates schematically the flexible printed circuit structure of FIG. 3a in operation;

FIG. 5a illustrates schematically charging of the flexible printed circuit structure;

FIG. 5b illustrates schematically discharging of the flexible printed circuit structure;

FIG. 6a illustrates schematically an electrical connector comprising a metallic interconnector;

FIG. 6b illustrates schematically an electrical connector comprising an electrically conductive adhesive;

FIG. 6c illustrates schematically a flexible printed circuit structure in origami flex form;

FIG. 7a illustrates schematically two flexible printed circuit structures connected in series;

FIG. 7b illustrates schematically two flexible printed circuit structures connected in parallel;

FIG. 8 illustrates schematically a device comprising the apparatus described herein;

FIG. 9 illustrates schematically a computer readable media providing a program; and

FIG. 10 illustrates schematically a method of producing the apparatus described herein.

### DESCRIPTION

In electrical circuits, batteries and capacitors are used to provide other components with electrical power. These power supplies operate in completely different ways, however. Batteries use electrochemical reactions to generate electricity. They comprise two electrical terminals (electrodes) separated by an electrolyte. At the negative electrode (the anode), an oxidation reaction takes place which produces electrons. These electrons then flow around an external circuit from the anode to the positive electrode (the cathode) causing a reduction reaction to take place at the cathode. The oxidation and reduction reactions may continue until the reactants are completely converted. Importantly though, unless electrons are able to flow from the anode to the cathode via the external circuit, the electrochemical reactions cannot take place. This allows batteries to store electricity for long periods of time. In contrast, capacitors store charge electrostatically, and are not capable of generating electricity.

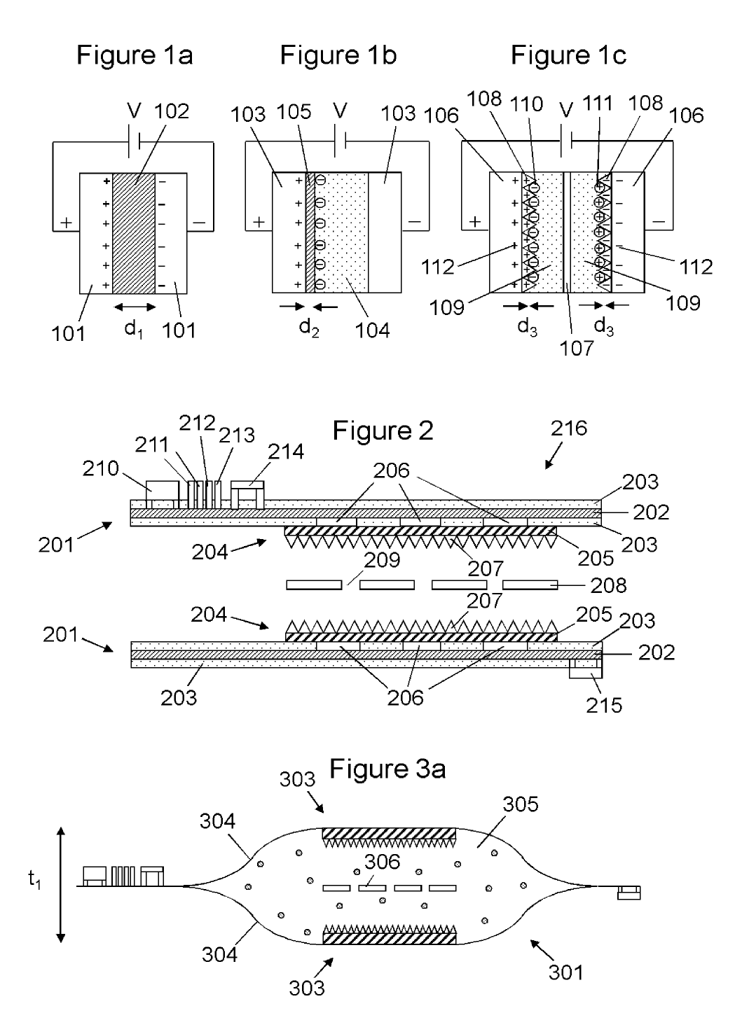

FIG. 1a illustrates schematically a capacitor, comprising a pair of electrical plates 101 separated by an electrical insulator 102. When a potential difference is applied between the plates 101, positive and negative electrical charges build up on opposite plates. This produces an electric field across the insulator 102 which stores electrical energy. The amount of energy stored is proportional to the charge on the plates, and inversely proportional to the separation of the plates, d₁. Therefore, the energy storage of a capacitor can be increased by increasing the size of the plates 101 or by reducing the thickness of the insulator 102. Device miniaturisation governs the maximum plate size, whilst material properties dictate the minimum insulator thickness that can be used without conduction of the insulator 102 (breakdown).

FIG. 1b illustrates schematically an electrolytic capacitor. Electrolytic capacitors use a special technique to minimise the plate spacing, d₂. They consist of two conductive plates 103 separated by a conducting electrolyte 104. When a potential difference is applied, the electrolyte 104 carries charge between the plates 103 and stimulates a chemical reaction at the surface of one of the plates. This reaction creates a layer of insulating material 105 which prevents the flow of charge. The result is a capacitor with an ultrathin dielectric layer 105 separating a conducting plate 103 from a conducting electrolyte 104. In this configuration, the electrolyte 104 effectively serves as the second plate. Since the insulating layer 105 is only a few molecules thick, electrolytic capacitors are able to store a greater amount of energy than conventional parallel plate capacitors.

FIG. 1c illustrates schematically an embodiment of a so-called supercapacitor. Supercapacitors (also known as electric double layer capacitors, ultracapacitors, pseudocapacitors and electrochemical double layer capacitors) have similarities to both electrolytic and conventional capacitors. A supercapacitor has two electrically conducting plates 106 that are separated by a dielectric material (a separator) 107. The plates 106 are coated in a porous material 108 such as powdered carbon to increase the surface area of the plates 106 for greater charge storage. Like an electrolytic capacitor (and also a battery), a supercapacitor contains an electrolyte 109 between the conducting plates 106. When a potential difference is applied between the plates, the electrolyte 109 becomes polarised. The potential on the positive plate attracts the negative 110 ions in the electrolyte 109, and the potential on the negative plate attracts the positive ions 111. The dielectric separator 107 is used to prevent direct physical contact (and therefore electrical contact) between the plates 106. The separator 107 is made from a porous material to allow the ions 110, 111 to flow towards the respective plates 106.

Unlike batteries, the applied potential is kept below the breakdown voltage of the electrolyte 109 to prevent electrochemical reactions from taking place at the surface of the plates 106. For this reason, a supercapacitor cannot generate electricity like an electrochemical cell. Also, without electrochemical reactions taking place, no electrons are generated. As a result, no significant current can flow between the electrolyte 109 and the plates 106. Instead, the ions 110, 111 in solution arrange themselves at the surfaces of the plates 106 to mirror the surface charge 112 and form an insulating “electric double layer”. In an electric double layer (i.e. a layer of surface charge 112 and a layer of ions 110, 111), the separation, d₃, of the surface charges 112 and ions 110, 111 is on the order of nanometers. The combination of the electric double layer and the use of a high surface area material 108 on the surface of the plates 106 allow a huge number of charge carriers to be stored at the plate-electrolyte interface. In an embodiment, the high surface area material 108 comprises carbon nanotubes and/or carbon nanohorns.

Supercapacitors have several advantages over batteries, and as a result, have been tipped to replace batteries in many applications. They function by supplying large bursts of current to power a device and then quickly recharging themselves. Their low internal resistance, or equivalent series resistance (ESR), permits them to deliver and absorb these large currents, whereas the higher internal resistance of a traditional chemical battery may cause the battery voltage to collapse. Also, whilst a battery generally demands a long recharging period, supercapacitors can recharge very quickly, usually within a matter of minutes. They also retain their ability to hold a charge much longer than batteries, even after multiple rechargings. When combined with a battery, a supercapacitor can remove the instantaneous energy demands that would normally be placed on the battery, thereby lengthening the battery lifetime.

Whereas batteries often require maintenance and can only function well within a small temperature range, supercapacitors are maintenance-free and perform well over a broad temperature range. Supercapacitors also have longer lives than batteries, and are built to last until at least the lifetime of the electronic devices they are used to power. Batteries, on the other hand, typically need to be replaced several times during the lifetime of a device.

Supercapacitors are not without their drawbacks, however. Despite being able to store a greater amount of energy than conventional and electrolytic capacitors, the energy stored by a supercapacitor per unit weight is considerably lower than that of an electrochemical battery. In addition, the working voltage of a supercapacitor is limited by the electrolyte breakdown voltage, which is not as issue with batteries.

In FIG. 2, there is illustrated a supercapacitor integrated within a flexible printed circuit (FPC) structure 216. The use of an FPC structure 216 provides a “flex-to-install solution”. Flex-to-install refers to a circuit which is bent or folded during device assembly, but which undergoes minimal flexing during the lifetime of the device. If the FPC structure 216 is sufficiently durable, it may also be suitable for dynamic flex applications in which the circuit board is required to bend both during and after device assembly.

The apparatus comprises two FPC boards 201, each comprising a layer of electrically conductive material 202. In this embodiment, the layer of electrically conductive material 202 on each FPC board 201 is coated on either side by a layer of electrically insulating material 203. Subtraction of the insulating material 203 is used to define conductive traces in the electrically conductive material 202. The insulating material 203 is also used to protect the electrically conductive material 202 from the external environment.

Each FPC board 201 further comprises a capacitive element 204 with an electrically conductive region 205. The electrically conductive regions 205 are electrically connected with the layers of electrically conductive material 202, e.g. by vertical interconnect access (VIA) connections 206. In an embodiment, the capacitive elements 204 also comprise a high surface area material 207 on top of the electrically conductive regions 205, the material 207 comprising a mixture of one or more of activated carbon (AC), multiple wall carbon nanotubes (MWNTs), carbon nanohorns (CNHs), carbon nanofibers (CNFs) and carbon nano-onions (CNOs). AC, MWNTs, CNHs, CNFs and CNOs are used because of their large electrical conductivity and high surface area. As mentioned earlier, the high surface area allows adsorption of large numbers of electrolyte ions onto the surface of the capacitive elements 204.

The high surface area material 207 may be prepared by mixing different proportions of AC, MWNTs and CNHs together using polytetrafluoroethylene (PTFE) as a binder and acetone as a solvent, and homogenising the mixture by stirring. In an embodiment, the resulting slurry is applied by rolling the mixture onto the surface of each electrically conductive region 205. The FPC boards 201 are then annealed at 50° C. for 20 minutes to drive off the solvent and consolidate the mixture. To maximise its surface area and electrical conductivity, the high surface material 207 is applied to the electrically conductive regions 205 as a thin film.

As shown in FIG. 2, the FPC boards 201 are configured such that the electrically conductive regions 205 (now coated in the high surface area material 207) are facing one another, sandwiching a thin dielectric separator 208 therebetween. The separator 208 prevents direct physical contact (and therefore electrical contact) between the capacitive elements 204, but comprises a number of pores 209 to enable the ions of the electrolyte to move towards the high surface area material 207 when a potential difference has been applied between the capacitive elements 204.

The electrically conductive regions 205 may be formed from a variety of different materials, such as copper, aluminium or carbon. The choice of material affects the physical and electrical properties of the supercapacitor. Using carbon, supercapacitors with an ESR of ˜3Ω can be produced. Furthermore, the resistance between the electrically conductive layer 202 and the electrically conductive region 205 may be reduced by increasing the number or size of the electrical connections (VIAs) 206. The resistance may also be reduced by removing insulating material 203 adjacent the electrically conductive region 205 such that electrically conductive region 205 can be deposited directly onto the electrically conductive layer 202. The electrically conductive regions 205 may also comprise a surface finish (coating) to protect the electrically conductive regions 205 or to modify their structural or material properties. Possible surface materials include nickel-gold, gold, silver, or an organic surface protection (OSP) material.

As mentioned in the background section, supercapacitors may be used to power multimedia enhancement modules in portable electronic devices. In the present embodiment, the FPC structure 216 (within which the supercapacitor is integrated) forms the multimedia enhancement module, with the various components of the module physically (and electrically) connected to the FPC boards 201. In FIG. 2, a surface mounted (SMD) LED 210, two ceramic caps 211, an indicator LED 212, an inductor 213, and a supercapacitor charger and LED driver circuit 214 are (electrically) connected to the electrically conductive layer 202 of the upper FPC board 201, whilst a board-to-board (B2B) connector 215 is (electrically) connected to the electrically conductive layer 202 of the lower FPC board 201. The various electrical components may be soldered or ACF (anisotropic conductive film) contacted to the FPC boards 201. The electrically conductive layers 202 are used to route power to and from the supercapacitor and module components, and the B2B connector 215 (electrically) connects the FPC structure 216 to the main board of the electronic device.

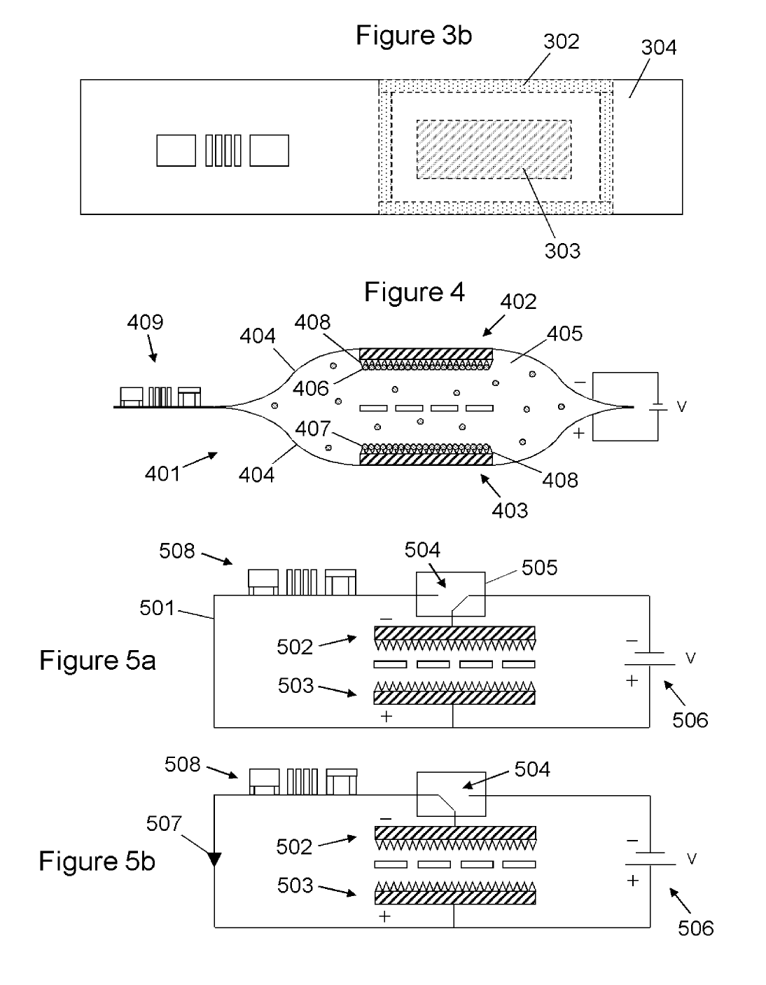

An electrolyte is required between the capacitive elements 204 to enable the storage of electrical charge. To achieve this, the FPC boards 201 are configured to form a chamber within which the electrolyte can be contained. The chamber is illustrated in cross-section in FIG. 3a, and in plan view in FIG. 3b. To create the chamber 301, a border 302 around the capacitive elements 303 is defined as shown in FIG. 3b. The FPC boards 304 are then sealed together at the border 302 to prevent the electrolyte 305 (which may be a gel or liquid-type electrolyte) from leaking out or evaporating during use. The FPC boards 304 may be sealed by heat lamination, vacuum packing or standard FPC punching processes. A small region (not shown) of the border 302 may remain unsealed until the electrolyte 305 has been introduced into the chamber 301.

In another embodiment, a ring may be incorporated into the FPC structure to form a chamber. In this embodiment (not shown), the ring is positioned around the capacitive elements 303 and sandwiched between the FPC boards 304. In practise, this may involve placing a first FPC board face-up on a flat surface; placing the ring (which has a diameter of at least the largest in-plane dimension of the capacitive elements 303) around the capacitive element of this FPC board; sealingly attaching the ring to the FPC board; filling the ring with electrolyte 305; placing a second FPC board face-down on top of the first FPC board such that the capacitive element of the second FPC board is contained within the ring and facing the other capacitive element; and sealingly attaching the second FPC board to the ring. Ideally, the thickness of the ring should be substantially the same as the total thickness of the FPC structure. Nevertheless, due to the flexibility of the FPC boards 304, the ring thickness may deviate from the total thickness of the FPC structure and still allow formation of the chamber.

In another embodiment, the ring may comprise an aperture. In this embodiment, the electrolyte may be introduced to the chamber via the aperture and subsequently sealed to retain the electrolyte 305.

It should be noted, however, that the thickness, t₁, of the chamber 301 is exaggerated in FIG. 3a. In practice, the capacitive elements 303 and separator 306 are in physical contact to minimise the thickness of the chamber 301. In another embodiment, the capacitive elements 303 may simply be spaced apart from one another. This configuration would remove the need for a separator 306, but may be difficult to maintain if the FPC structure is physically flexible.

FIG. 4 illustrates schematically the flexible printed circuit structure of FIG. 3a in operation. To charge the apparatus, a potential difference is applied across the capacitive elements 402, 403. This may be performed by connecting the positive and negative terminals of a battery (or other power supply) to the electrically conductive layers of the respective FPC boards 404. In practice, however, the electrically conductive layers of the FPC boards 404 would typically be connected to a charger circuit (not shown) which itself is connected to the battery or other power supply. Application of the potential difference polarises the electrolyte 405, causing adsorption of the positive 406 and negative 407 ions onto the exposed surfaces of the high surface area material 408 of the negatively 402 and positively 403 charged capacitive elements, respectively. The charge stored at the interface between the high surface area material 408 and the electrolyte 405 can be used to power the components of the multimedia enhancement module 409 when the supercapacitor discharges.

A variety of different configurations may be used to discharge the apparatus. In one configuration shown in FIGS. 5a and 5b, an electrical connector 501 is provided between the electrically conductive layers of the FPC boards. The electrical connector 501 allows electrons to flow from the negatively charged capacitive element 502 to the positively charged capacitive element 503. To prevent this flow of electrons when the apparatus is charging, however, the apparatus may include a switch 504 configured to connect and disconnect the electrical connector 501 (i.e. make or break the connection). Disconnection of the electrical connector 501 allows the apparatus to be charged, whilst connection of the electrical connector 501 allows the apparatus to be discharged. The switch 504 may be provided within a charger circuit 505. When the switch 504 is in a first position as in FIG. 5a, it connects the apparatus to the power supply 506, allowing the capacitive elements 502, 503 to be charged. Once the capacitive elements 502, 503 have been charged, movement of the switch 504 to a second position as in FIG. 5b disconnects the apparatus from the power supply 506 and connects the capacitive elements 502, 503 to the electrical components 508. This allows electrons to flow 507 from the negatively charged capacitive element 502 to the positively charged capacitive element 503, thereby discharging the apparatus. The electrical components 508 may be electrically connected to the electrically conductive layers of one or both of the FPC boards. Once the apparatus has been discharged, movement of the switch 504 back to the first position again as in FIG. 5a causes the power supply 506 to recharge the apparatus. A person skilled in the art will appreciate that there are other ways of configuring the circuit to charge and discharge the apparatus, the configuration shown in FIGS. 5a and 5b constituting just one possible implementation.

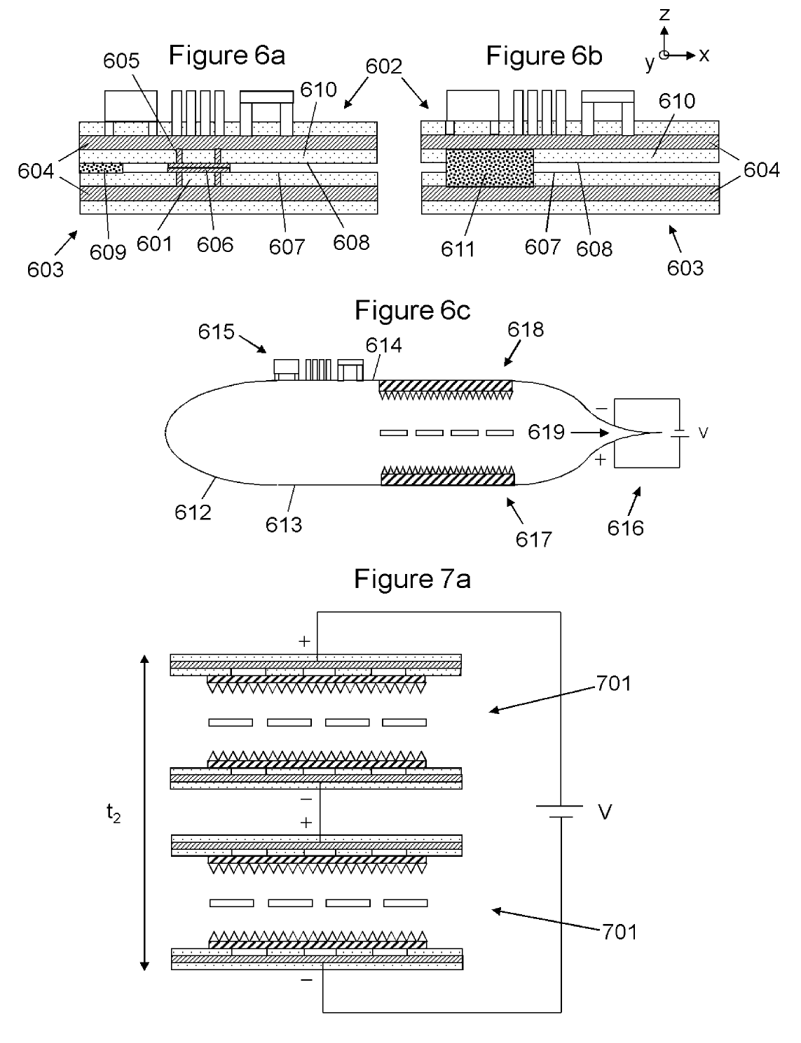

FIG. 6a illustrates schematically an electrical connector comprising a metallic interconnector. The electrical connector may comprise a metallic interconnector such as a vertical interconnect access (VIA) connector. To form this connector, holes 601 are made in the insulating material 610 of each FPC board 602, 603 (possibly by drilling) to reveal the electrically conductive layers 604 (from which the bus lines of the FPC boards 602, 603 are formed). The internal surface of each hole 601 is then plated with an electrically conductive coating 605 (typically a metal such as copper) using a partial plating process such that the electrically conductive material 605 is in electrical contact with the electrically conductive layer 604. Alternatively, the holes 601 may be filled with electrically conductive material, rings or rivets to form the electrical connection. Electrically conductive pads 606 are then deposited on the top surface 607 and bottom surface 608 of the bottom 603 and top 602 FPC boards, respectively, in electrical contact with the electrically conductive coating 605 of each hole 601. The pads 606 may be formed using a lithographic procedure, but could be formed using the plating/filling process by simply extending deposition of the electrically conductive coating 605 from within the holes 601 to the surfaces 607, 608 of the FPC boards 602, 603. Once the pads 606 have been formed, the FPC boards 602, 603 are positioned one on top of the other. The holes 601 of the top FPC board 602 are aligned with the holes 601 of the bottom FPC board 603 so that the pads 606 on the top surface 607 of the bottom FPC board 603 are in physical and electrical contact with the pads 606 on the bottom surface 608 of the top FPC board 602. In this way, the pads 606 and electrically conductive coating 605 of both FPC boards 602, 603 form an electrical path between the electrically conductive layers 604. In order to maintain the alignment (and therefore electrical connection), however, the FPC boards 602, 603 must be held in place. This may be achieved using an adhesive 609 between the FPC boards 602, 603 to prevent movement therebetween.

FIG. 6b illustrates schematically an electrical connector comprising an electrically conductive adhesive. In an embodiment, the electrically conductive adhesive is an anisotropic conductive adhesive (ACA), encompassing both anisotropic conductive film (ACF) and anisotropic conductive paste (ACP). The ACA material consists of an adhesive polymer containing electrically conductive particles.

ACA may be applied to the surfaces of the FPC boards to form an electrical connection. To achieve this, the electrically conductive layers 604 must first be exposed. This is performed by removing some of the insulating material 610 above and below the electrically conductive layers 604 of the bottom 603 and top 602 FPC boards, respectively (possibly by drilling). Once the electrically conductive layers 604 are exposed, ACA 611 is deposited on the top surface 607 of the bottom FPC board 603 in physical contact with the exposed material of the electrically conductive layers 604. This may be done using a lamination process for ACF, or either a dispense or printing process for ACP. The top FPC board 602 is then placed in position over the bottom FPC board 603 (i.e they are aligned with one another), and the two FPC boards 602, 603 are pressed together to mount the top FPC board 602 on the bottom FPC board 603. The mounting step may be performed using no heat, or using just enough heat to cause the ACA 611 to become slightly tacky.

Using Hitachi™ chemical AC2051/AC2056 as the ACA, the temperature, pressure and time parameters required to successfully mount the top FPC board 602 on the bottom FPC board 603 are 80° C., 10 kgf/cm² and 5 secs, respectively. Using 3M™ ACF 7313 as the ACA, the temperature, pressure and time parameters are 100° C., 1-15 kgf/cm² and 1 sec, respectively.

Bonding is the final step in the process required to complete the ACA assembly. During lamination and mounting, the temperature may range from ambient to 100° C. with the heat applied for 1 second or less. In order to bond the FPC boards 602, 603 together, however, a greater amount of thermal energy is required, firstly to cause the ACA 611 to flow (which allows the FPC boards 602, 603 to be positioned for maximum electrical contact), and secondly to cure the ACA 611 (which allows a lasting and reliable bond to be created). Depending on the specific ACA and FPC materials used, the required temperature and heating time may range from 130-220° C. and 5-20 secs, respectively. The bonding step is performed by pressing a bonding tool head (not shown) onto the top FPC board 602. The tool head is maintained at the required temperature and is applied to the top FPC board 602 at the required pressure for the required period of time. The required pressure may range from 1-4 MPa (˜10-40 kgf/cm²) over the entire area under the tool head.

Using Hitachi™ chemical AC2051/AC2056 as the ACA, the temperature, pressure and time parameters required to successfully bond the top FPC board 602 to the bottom FPC board 603 are 170° C., 20 kgf/cm² and 20 secs, respectively. Using 3M™ ACF 7313 as the ACA, the temperature, pressure and time parameters are 140° C., 15 kgf/cm² and 8-12 secs, respectively.

When the ACA 611 is compressed, the electrically conductive particles contained within the adhesive polymer are forced into physical contact with one another, thereby creating an electrical path from the electrically conductive layer 604 of the top FPC board 602 to the electrically conductive layer 604 of the bottom FPC board 603. The electrical path is highly directional (hence anisotropic conductive adhesive). It allows current to flow in the z-axis, but prevents the flow of current in the x-y plane. This feature is important in the present apparatus, because it prevents (or minimises) electrical shorting of the electrolyte. As the ACA 611 cures, the electrically conductive particles are fixed in the compressed form, thereby maintaining good electrical conductivity in the z-axis.

In an embodiment, a conductive pressure setting adhesive (PSA) is used to bond the FPC boards together. A PSA is an adhesive which forms a bond with an adherend under pressure alone. It is used in pressure setting tapes, labels, note pads, automobile trim, and a wide variety of other products. As the name suggests, the degree of bonding is influenced by the amount of pressure applied, but surface factors such as smoothness, surface energy, contaminants, etc can also affect adhesion. PSAs are usually designed to form and maintain a bond at room temperature. The degree of adhesion and shear holding ability often decrease at low temperatures and high temperatures, respectively. Nevertheless, special PSAs have been developed to function at temperatures above and below room temperature. It is therefore important to use a PSA formulation that is suitable for use at the typical operating temperatures of the electronic circuitry.

As described previously, the FPC boards need to be sealed together in order to form the chamber and prevent the electrolyte from escaping. An electrically conducting or non-conducting adhesive may be used for this purpose. In an embodiment, the ACA or conducting PSA used to provide the electrical connection between the FPC boards is also used to seal the structure. In this configuration, the fabrication steps of providing the electrical connection and sealing the structure are combined as a single step. In another embodiment, the step of providing the electrical connector may be performed separately from the step of sealing the structure. In this latter embodiment, either the same or different adhesives could be used for each step.

FIG. 6c illustrates schematically a flexible printed circuit structure in origami flex form. In an embodiment, a single FPC board 612 may be bent around onto itself to define the chamber, rather than two separate FPC boards 602, 603 being used (although one side of the structure 619 will still need to be sealed to contain the electrolyte). This configuration is referred to as the “origami flex form”. An advantage of the origami flex form is that the electrically conductive layer 604 is continuous from one side 613 (i.e. bottom FPC 603) of the structure to the other side 614 (i.e. top FPC 602). This feature negates the need to provide an additional electrical connector between the FPC boards 602, 603 in order to power the electrical components 615. Again, to control charging and discharging of the apparatus, a switch (not shown) is required to make and break the electrical connection, otherwise the charge will simply flow around the circuit between the opposite terminals of the battery 616 (or other power supply) without being stored at the capacitive elements 617, 618.

As previously mentioned, the working voltage of a supercapacitor is limited by the breakdown voltage of the electrolyte. There are two types of electrolyte typically used in supercapacitors—aqueous electrolytes and organic electrolytes. The maximum voltage for supercapacitor cells that use aqueous electrolytes is the breakdown voltage of water, ˜1.1V, so these supercapacitors typically have a maximum voltage of 0.9V per cell. Organic electrolyte supercapacitors are rated in the range of 2.3V-2.7V per cell, depending on the electrolyte used and the maximum rated operating temperature. In order to increase the working voltage of a supercapacitor, several supercapacitor cells may be connected in series.

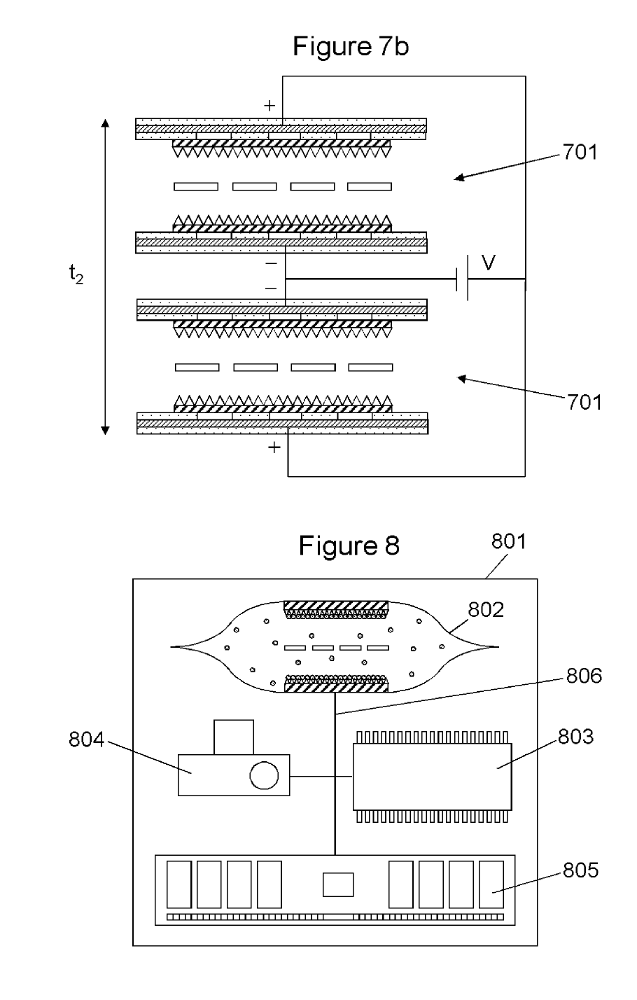

FIG. 7a shows two FPC-integrated supercapacitors 701 connected in series. In this configuration, the total capacitance and maximum working voltage are given by 1/Cₜₒₜₐₗ=1/C₁+1/C₂ and Vₘₐₓ=V₁+V₂, respectively. Therefore, although the working voltage is increased relative to a single FPC-integrated supercapacitor 701, the capacitance of the stack is reduced. The capacitance may be increased by connecting the FPC-integrated supercapacitors 701 in parallel, as shown in FIG. 7b. In this configuration, the total capacitance and maximum working voltage are given by Cₜₒₜₐₗ=C₁+C₂ and Vₘₐₓ=V₁=V₂, respectively. Therefore, although the capacitance of the stack is increased, the working voltage remains the same as that of a single FPC-integrated supercapacitor 701.

To test the behaviour of the FPC-integrated supercapacitors, cyclic voltammetry experiments were performed using a 5 cm²-area supercapacitor with a 1M solution of tetraethylammonium tetrafluoroborate in acetonitrile as the electrolyte. Cyclic voltammetry is a type of potentiodynamic electrochemical measurement which involves increasing the electrode potential linearly with time whilst measuring the current. This ramping is known as the experiment scan rate (V/s). In this case, a scan rate of 50 mV/s was used. Once the voltage reaches a set potential, the potential ramp is inverted. This inversion is usually performed a number of times during a single experiment. The current is then plotted against the applied voltage to give the cyclic voltammogram trace.

This experiment produced a rectangular trace (not shown) indicating good capacitor behaviour. Furthermore, during the experiment the applied voltage was increased to 2.7V without degradation of the supercapacitor performance.

Following this, the effect of varying the number of separator layers in the supercapacitor was studied. Again, these experiments were performed using 5 cm²-area supercapacitors with a 1M solution of tetraethylammonium tetrafluoroborate in acetonitrile as the electrolyte. It was found that an increase in the number of separator layers from 1 to 2 caused an increase in capacitance and a decrease in ESR. The same trend was observed when the number of separator layers was increased from 2 to 3. This may be attributed to a greater number of pores available to accommodate the ionic species in the electrolyte, which may allow more ions to interact with the high surface material. When the number of separator layers was increased beyond 3, however, there was no further change in capacitance.

Charge-discharge (V) curves (not shown) cycled at ±1 mA (+1 mA for charging the cell and −1 mA for discharging the cell, each cycle lasting 20 secs) revealed capacitances of between 250-649 mF with ESRs of between 5.35-1.8Ω. The capacitance was deduced from the slope of the discharging curve where C=l/(dV/dt), C is the capacitance of the cell in farads, l is the discharge current in amperes, and dV/dt is the slope in volts per second. The direct current ESR was calculated using ESR=dV/dl, where dV is the voltage drop at the beginning of the discharge in volts, and dl is the current change in amperes.

The effect of varying the high surface material in the supercapacitor was also studied. Three formulations of high surface material were tested: 97% activated carbon and 3% PTFE (binder), (ii) 87% activate carbon, 10% carbon nanotubes and 3% PTFE, and (iii) 77% activated carbon, 20% carbon nanotubes and 3% PTFE. Again, these experiments were performed using 5 cm²-area supercapacitors with a 1M solution of tetraethylammonium tetrafluoroborate in acetonitrile as the electrolyte.

Cyclic voltammetry experiments produced rectangular traces (not shown) for each sample, indicating good capacitor behaviour. Furthermore, charge-discharge (V) curves (not shown) cycled at ±1 mA revealed respective capacitances of 476, 500 and 649 mF with respective ESRs of 2.3, 1.8 and 1.8Ω. The increase in capacitance and decrease in ESR with nanotube content may be attributed to the high surface area and high electrical conductivity of the carbon nanotubes.

FIG. 8 illustrates schematically an electronic device 801 comprising an FPC-integrated supercapacitor 802. The device also comprises a processor 803, a multimedia apparatus 804, and a storage medium 805, which may be electrically connected to one another by a data bus 806. The device 801 may be a portable telecommunications device, whilst the multimedia apparatus 804, may be a built-in camera, loudspeaker or transmitter of electromagnetic signals.

The FPC structure 802 (within which the supercapacitor is integrated) forms a multimedia enhancement module for the multimedia apparatus 804. The supercapacitor itself is used to store electrical charge for powering the various components of the multimedia enhancement module which are physically (and electrically) connected to the FPC boards. The multimedia enhancement module may be a camera flash module, a loudspeaker driver module, or a power amplifier module for electromagnetic signal transmission.

The processor 803 is configured for general operation of the device 801 by providing signalling to, and receiving signalling from, the other device components to manage their operation. In particular, the processor 335 is configured to provide signalling to control the charging and discharging of the FPC-integrated supercapacitor 802. Typically, the supercapacitor 802 will discharge whenever the multimedia enhancement module requires a short current burst. Where the multimedia apparatus 804 is a camera, for example, a short burst of current will be required whenever the user of the device 801 wishes to take a photograph using the camera flash. In this embodiment, the processor 803 provides signalling to instruct the supercapacitor 802 to discharge and provide the flash with the required current. After the supercapacitor 802 has discharged, the processor 803 instructs the supercapacitor 802 to recharge using a connected battery (or other power supply). The use of a supercapacitor 802 therefore removes the instantaneous energy demands that would normally be placed on the battery. The processor 803 may provide signalling to operate a switch, operation of the switch configured to break and make the electrical connection between the FPC boards to cause charging and discharging of the supercapacitor 802, respectively.

The storage medium 805 is configured to store computer code required to operate the apparatus. The storage medium 805 may also be configured to store device settings. For example, the storage medium 805 may be used to store specific current/voltage setting for the various electrical components (e.g. the components of the multimedia enhancement module or the components of the multimedia apparatus 804). In particular, the storage medium 805 may be used to store the voltage setting of the supercapacitor 802. The processor 803 may access the storage medium 805 to retrieve the desired information before instructing the supercapacitor 802 to recharge using the battery. The storage medium 805 may be a temporary storage medium such as a volatile random access memory. On the other hand, the storage medium 805 may be a permanent storage medium such as a hard disk drive, a flash memory, or a non-volatile random access memory.

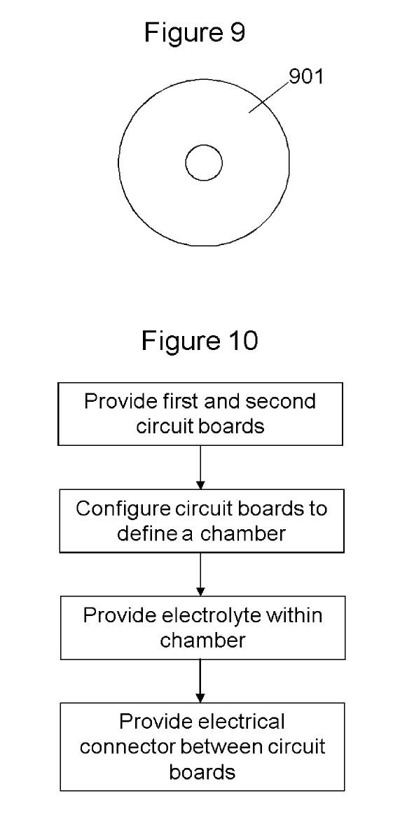

FIG. 9 illustrates schematically a computer/processor readable medium 901 providing a computer program according to one embodiment. In this example, the computer/processor readable medium 901 is a disc such as a digital versatile disc (DVD) or a compact disc (CD). In other embodiments, the computer/processor readable medium 901 may be any medium that has been programmed in such a way as to carry out an inventive function. The computer/processor readable medium may be a removable memory device such as a memory stick or memory card (SD, mini SD or micro SD).

The computer program may comprising computer code configured to control the charging and discharging of an apparatus, the apparatus comprising first and second circuit boards, and an electrolyte, the first and second circuit boards each comprising a capacitive element, the apparatus configured such that a chamber is defined between the first and second circuit boards with the capacitive elements contained therein and facing one another, the chamber comprising the electrolyte, wherein the apparatus is configured to store electrical charge when a potential difference is applied between the capacitive elements, the apparatus further comprising an electrical connector between the first and second circuit boards and a switch, the electrical connector configured to enable a flow of electrical charge from the capacitive elements to provide power to one or more electrical components when the apparatus discharges, the switch configured to connect and disconnect the electrical connector, disconnection of the electrical connector configured to allow the apparatus to be charged, and connection of the electrical connector configured to allow the apparatus to be discharged, the computer program comprising computer code configured to operate the switch to cause charging and discharging of the apparatus.

FIG. 10 illustrates schematically a method according to an example embodiment of the invention. At 1001, first and second circuit boards are provided. At 1002, circuit boards are configured to define a chamber. At 1003, an electrolyte is provided within the chamber. At 1004, an electrical connector is provided between the circuit boards.

Without in any way limiting the scope, interpretation, or application of the claims appearing below, a technical effect of one or more of the example embodiments disclosed herein is that a compact supercapacitor structure is provided. Another technical effect of one or more of the example embodiments disclosed herein is that the supercapacitor does not suffer from electrolyte swelling. Another technical effect of one or more of the example embodiments disclosed herein is that the supercapacitor structure has a form factor suited for attachment to the circuit boards of portable electronic devices. Another technical effect of one or more of the example embodiments disclosed herein is that the number of manufacturing steps in the assembly phase is reduced. Another technical effect of one or more of the example embodiments disclosed herein is that the supercapacitor can be implemented close to the load circuit. Another technical effect of one or more of the example embodiments disclosed herein is that power can be received from local sources without the resistive and inductive losses caused by electrical junctions (e.g. connectors, vias, pogo pins, solder contacts etc).

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus, comprising first and second circuit boards, and an electrolyte,
the first and second circuit boards each comprising a capacitive element, the apparatus being configured such that a chamber is defined between the first and second circuit boards with the capacitive elements contained therein and facing one another, the chamber comprising the electrolyte,
the apparatus being configured to store electrical charge when a potential difference is applied between the capacitive elements, and
the apparatus further comprising an electrical connector between the first and second circuit boards, the electrical connector configured to enable a flow of electrical charge from the capacitive elements to provide power to one or more electrical components when the apparatus discharges.

2. The apparatus of claim 1, the apparatus further comprising a power supply configured to apply the potential difference between the capacitive elements.

3. The apparatus of claim 1, the apparatus further comprising a switch configured to connect and disconnect the electrical connector, wherein disconnection of the electrical connector is configured to allow the apparatus to be charged, and connection of the electrical connector is configured to allow the apparatus to be discharged.

4. The apparatus of claim 1, wherein the electrical connector between the first and second circuit boards comprises an electrically conductive adhesive.

5. The apparatus of claim 4, wherein the electrically conductive adhesive comprises one or more of the following: an anisotropic conductive adhesive and a conductive pressure setting adhesive.

6. The apparatus of claim 1, wherein the first and second circuit boards are sealed together to contain the electrolyte within the chamber.

7. The apparatus of claim 1, wherein the electrical connector between the first and second circuit boards comprises an electrically conductive adhesive, the electrically conductive adhesive further configured to seal the first and second circuit boards together to contain the electrolyte within the chamber.

8. The apparatus of claim 1, wherein the electrical connector between the first and second circuit boards comprises a metallic interconnector configured to physically and electrically connect the first and second circuit boards.

9. The apparatus of claim 1, wherein the first and second circuit boards are different ends of the same circuit board which has been bent around onto itself to define the chamber.

10. The apparatus of claim 1, wherein the one or more electrical components are physically and electrically connected to one or both of the first and second circuit boards.

11. The apparatus of claim 1, wherein the apparatus is configured to be flexible.

12. The apparatus of claim 1, wherein the apparatus forms part of a multimedia enhancement module.

13. The apparatus of claim 1, wherein the apparatus is configured for use in a portable electronic device.

14. A method, comprising:
providing first and second circuit boards, the first and second circuit boards each comprising a capacitive element;
configuring the first and second circuit boards to define a chamber between the first and second circuit boards with the capacitive elements contained therein and facing one another;
providing an electrolyte within the chamber; and
providing an electrical connector between the first and second circuit boards to produce an apparatus, the apparatus comprising the first and second circuit boards, the electrolyte, and the electrical connector,
the apparatus being configured to store electrical charge when a potential difference is applied between the capacitive elements, and the electrical connector being configured to enable a flow of electrical charge from the capacitive elements to provide power to one or more electrical components when the apparatus discharges.

15. The method of claim 14, wherein providing an electrical connector between the first and second circuit boards comprises affixing the second circuit board to the first circuit board using an electrically conductive adhesive.

16. The method of claim 15, wherein affixing the second circuit board to the first circuit board comprises:
applying the electrically conductive adhesive to a surface of the first circuit board;
aligning the second circuit board with the first circuit board;
placing the second circuit board on top of the first circuit board in physical contact with the electrically conductive adhesive; and
applying at least one of pressure and heat to bond the second circuit board to the first circuit board via the electrically conductive adhesive.

17. The method of claim 14, wherein providing an electrical connector between the first and second circuit boards comprises:
making one or more holes in the first and second circuit boards to reveal bus lines;
plating the holes with an electrically conductive material to make electrical contact with the respective bus lines; and
aligning the holes of the first circuit board with the holes of the second circuit board such that the electrically conductive material of the holes in the first circuit board is in electrical contact with the electrically conductive material of the holes in the second circuit board to provide electrical connection of the respective bus lines.

18. A computer program product, comprising computer code configured to control at least one of charging and discharging of an apparatus, the apparatus comprising first and second circuit boards, and an electrolyte,
the first and second circuit boards each comprising a capacitive element, the apparatus configured such that a chamber is defined between the first and second circuit boards with the capacitive elements contained therein and facing one another, the chamber comprising the electrolyte,
the apparatus being configured to store electrical charge when a potential difference is applied between the capacitive elements,
the apparatus further comprising an electrical connector between the first and second circuit boards and a switch, the electrical connector configured to enable a flow of electrical charge from the capacitive elements to provide power to one or more electrical components when the apparatus discharges, the switch configured to connect and disconnect the electrical connector, disconnection of the electrical connector configured to allow the apparatus to be charged, and connection of the electrical connector configured to allow the apparatus to be discharged,
the computer program product comprising computer code configured to operate the switch to cause charging and discharging of the apparatus.
